(19) United States
(12) Patent Application Publication
(10) Pub. No.: US 2011/0218946 A1
(43) Pub. Date: Sep. 8, 2011

(54) PRESENTING CONTENT ITEMS USING TOPICAL RELEVANCE AND TRENDING POPULARITY

(75) Inventors: David Stern, Cambridge (GB); Ralf Herbrich, Cambridge (GB); Milad Shokouhi, Cambridge (GB); Thore Kurt Hartwig Graepel, Cambridge (GB)

(73) Assignee: Microsoft Corporation, Redmond, WA (US)

(21) Appl. No.: 12/717,109

(22) Filed: Mar. 3, 2010

(51) Int. Cl. G06F 17/30; G06F 15/18

(52) U.S. Cl. 706/12; 707/771; 707/722; 707/E17.014

(57) ABSTRACT

A user may request a presentation of a content item set, such as a social network comprising a set of status messages or an image database comprising a set of images. However, the volume and diversity of content items of the content item set may reduce the interest of the user in the presented content items. The potential interest of the user in the presented content items may be improved by selecting content items that are associated with one or more topics of potential interest to the user, and having a positive trending popularity among users of the content item set. Moreover, the interaction of the user with a presented content item may be monitored and used to determine the interest of the user in the topics associated with the presented content item and the popularity of the content item.

### BACKGROUND

Within the field of computing, many scenarios involve a presentation to a user of content items selected from a social content item set, such as news items from a news source, images from an image database, and social items from a social network. However, some of these content item sets may be frequently updated, and presenting all of the latest content items may overwhelm the user. Some techniques may involve presenting to the user a subset of content items, such as those generated by associate users who have a relationship with the user, or by presenting the newest content items of the content item set.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While some techniques for selecting a subset of content items for presentation to the user may be advantageous, it may be difficult to select content items that are potentially interesting to the user. For example, if the user is associated with various associate users based on shared interests, limiting the presented content items to those generated by the associate users may promote the interestingness of different content items. However, a user may have relationships with many associate users who each generate a large set of content items relating to many diverse interests, and this volume and diversity may diminish the potentially interesting selectivity among the content items.

Techniques may be devised and utilized that may improve the selectivity to content items that are of potential interest to the user. Such techniques involve the selection of content items that relate to a topic that is of interest to the user, and that have a positive trending popularity, which may be indicative, e.g., of a consensus determination of interestingness and/or significance to the user. By selecting content items based on both the topical relevance to the user and the positive trending popularity of the content item, the presentation of content items may be adjusted to improve the selectivity of content items from the content item set that the user may find potentially interesting.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation to a user of content items selected from a content item set.

FIG. 2 is an illustration of another exemplary scenario featuring a presentation to a user of content items selected from a content item set.

FIG. 3 is an illustration of an exemplary scenario featuring a presentation to a user of content items selected from a content item set in accordance with the techniques presented herein.

FIG. 4 is a flow chart illustrating an exemplary method of presenting to a user content items from a content item set.

FIG. 5 is a component block diagram illustrating an exemplary system for presenting to a user content items from a content item set.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a presentation to a user of content items selected from a content item set. As a first example, a news source may generate a set of news items, and may select a set of such news items from the news item set for presentation to a user. As a second example, an image database may store an image collection comprising images generated by various users, and may present for a user a set of such images. As a third example, a conversation forum may store a set of threads, comprising a post about a particular topic and a set of replies, and may present to a user a set of such threads. As a fourth example, a social network may store a set of comments generated by users (such as a status), and may present to a first user a set of comments submitted by other users who are associates (such as friends, family members, acquaintances, and colleagues) of the first user.

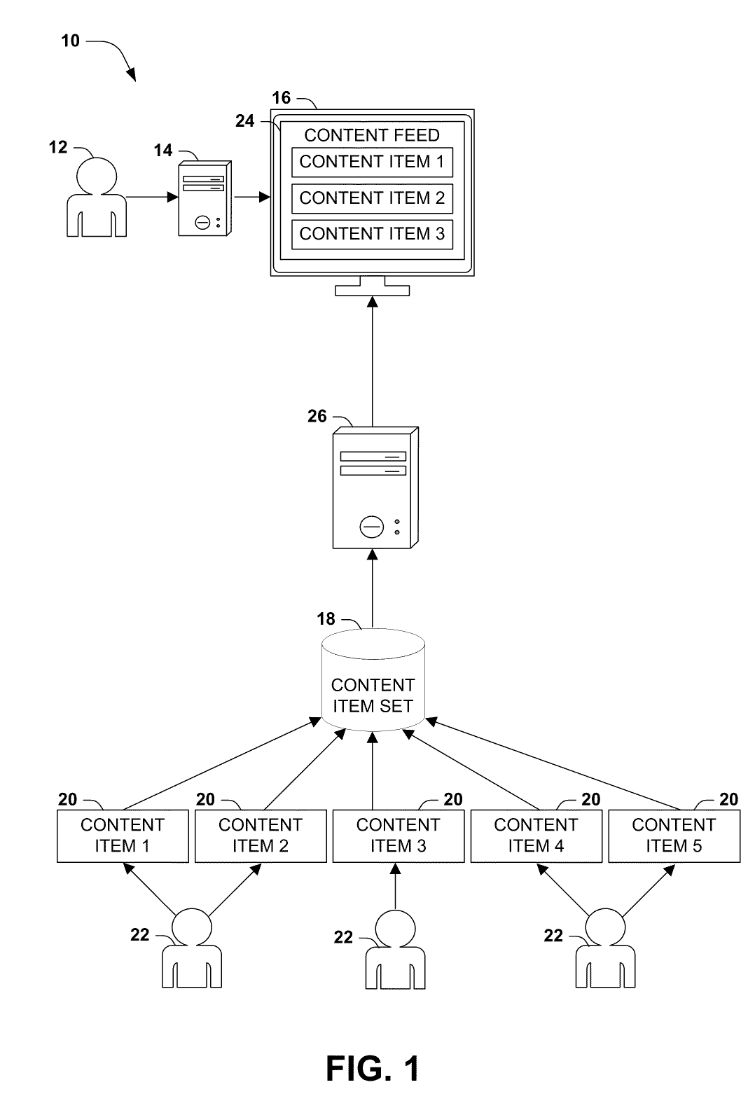

FIG. 1 presents an exemplary scenario 10 featuring a user 12 of a device 14 who wishes to access content stored in a content item set 18 comprising a set of content items 20, such as a series of images stored in an image database or a series of status messages by various authors 22 in a social network. The content item set 18 may be managed by a content server 26, e.g., a webserver configured to receive and fulfill requests of users 12 for presentations of the content item set 18. The user 12 submits a request to the content item set 18, which examines the content items 20 and generates a presentation for the user 12, e.g., a presentation 24 of the content items 20 that may be displayed on a display 16 attached to the device 14. The presentation 24 may be structured in many ways; e.g., the content items 20 may be presented in an arbitrary order, or may be ordered in various ways, such as sorted (in ascending or descending order) by the date of creation or addition to the content item set 18, or grouped based on the author 22 of the content item 20. The user 12 may therefore review the content stored in the content item set 18 based on the presentation 24 of selected content items 20. Moreover, as additional content items 20 are added to the content item set 18, the presentation 24 may be updated; e.g., the user 12 may request a subsequent presentation 24 featuring new content items 20, or the content item set 18 may proactively update the presentation 24 to include new content items 20.

In these and other scenarios, the content server 26 of the content item set 18 is requested to select a subset of content items 20 for inclusion in the presentation 24 to the user 12. However, it may be undesirable to present an arbitrary selection of content items 20. As a first example, the content item set 18 may be voluminous and diverse, and an arbitrary selection of content items 20 may include many content items 20 that are of little or no use or interest to the user 12. As a second example, the content item set 18 may include content items 20 that are authored or submitted at various times, and content items 20 that are newer or that have been more recently submitted may be of greater value to the user 12 than older content items 20; therefore, an arbitrary selection of content items 20 may include many that are stale, outdated, or superseded by a newer version of the same content item 20.

In order to improve the value of the presentation 24 to the user 12, the selection of content items 20 from the content item set 18 may be performed in view of various considerations. As a first example, the content items 20 may be selected according to the date of creation or addition to the content item set 18, such that recent content items 20 are preferentially selected and presented over less recent content items 20. As a second example, where content items 20 are generated by various authors 22, respective content items 20 may be preferentially selected according to the relationship of the author 22 to the user 12. In one such embodiment, a social network may include a map of association of the user 12 with associate users, such as first-order relationships with close friends and family members, second-order relationships with other friends and colleagues, and third-order relationships with casual acquaintances; and content items 20 generated by these associate users (as authors 22) may be preferentially selected based on the order of the relationship of the author 22 with the user 12. As a third example, the content server 26 may track the popularity of various content items 20 among users 12, and may select for inclusion in the presentation 24 to the user 12 content items 20 that are generally popular among users 12. Other considerations may also be included in the selection of content items 20 for inclusion in the presentation 24 to the user 12, such as the removal of duplicate content items 20 (e.g., multiple associate users submitting links to the same resource) and of content items 20 that have previously been presented to the user 12.

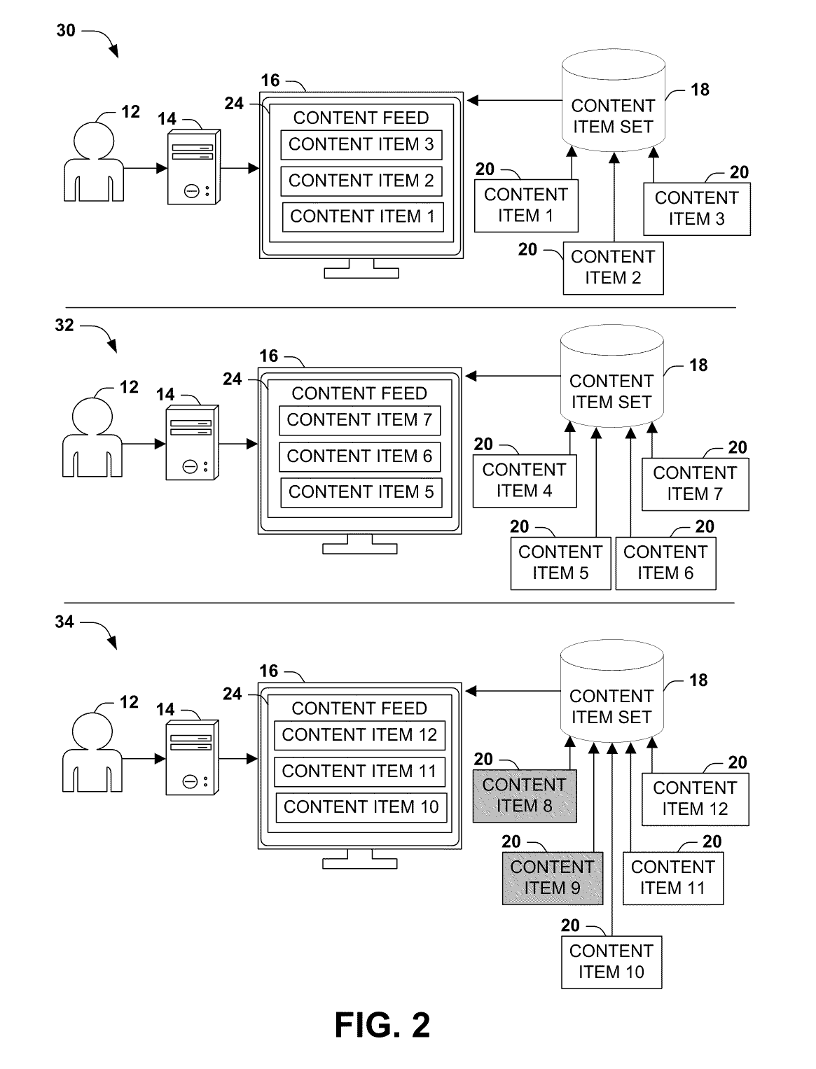

However, the inclusion of these comparatively simple aspects in the selection of content items 20 may still be inadequate for improving the value of the presentation 24 of selected content items 20 to the user 12, due in part to the rate at which content items 20 that may be added to the content item set 18. FIG. 2 illustrates an exemplary scenario featuring a sequence of time points respectively featuring a presentation 24 of content items 20 to a user 12 of a device 14. At a first time point 32, the user 12 may submit a request to view content in the content item set 18, and a presentation 24 may be generated comprising several of the content items 20 of the content item set 18. At a second time point 32, the user 12 may request a second presentation 24 of content from the content item set 18, after several new content items 20 have been added to the content item set 18 since the first time point 30. Although the content items set 18 includes four new content items 20, the presentation 24 may include only three of the new content items 20 to reduce information overload of the user 12. Therefore, the fourth content item 20 may be excluded from the presentation 24 at the second time point 32. In some scenarios, the user 12 might submit a subsequent request for presentation 24 of the content item set 18 before new content items 20 are received, and the subsequent presentation 24 may feature the omitted fourth content item 20. However, in the exemplary scenario of FIG. 2, at a third time point 34 at which the user 12 requests a third presentation 24 of content from the content item set 18, additional content items 20 have again been received; in addition to omitting the fourth content item 20 again, additional content items 20 (such as the eighth and ninth content items) are also omitted in order to restrict the presentation 24 to a manageable number of content items 20. This omission may be particularly disadvantageous if, e.g., the presentation 24 omits content items 20 that may be of potential interest to the user 12 (shown in FIG. 2 with gray shading.) As a first example, the omitted content items 20 may relate to topics of potential interest to the user 12, but may be omitted due to preferential selection of newer content items 20 that relate to topics that are not of potential interest to the user 12. As a second example, the omitted content items 20 may contain content that is currently popular with other users 12 (such as similar users, or associate users of the user 12) and that are also of potential interest to the user 12, but may be omitted due to preferential selection of other content items 20 that are of less potential interest, but that are submitted by authors 22 who have closer relationships with the user 12. In these and other examples that may be illustrated in FIG. 2, content items 20 that are not of potential interest to the user 12 are preferentially selected over content items 20 that are of potential interest to the user 12, thereby reducing the interest value of the presentation 24 to the user 12.

In view of these scenarios, techniques may be devised to generate presentations 24 of the content item set 18 for the user 12 that may include content items 20 of potential interest to the user 12. In particular, two aspects may be identified and utilized in the selection of content items 20 from the content item set 18. A first aspect relates to the topical relevance of a content item 20 to the interests of the user 12. If one or more topics of potential interest to the user 12 may be identified, and if respective content items 20 may be identified as associated with one or more topics, then the presentation 24 may be generated by selecting content items 20 associated with topics that are of potential interest to the user 12. A second aspect relates to the trending popularity of a content item 20, as indicated by the number of users 12 who (in various ways) express a measure of interest in the content item 20. Content items 20 that have a positive trending popularity, e.g., that are measured as having an increase in popularity over a comparatively short period of time, may be considered potentially interesting to users at large, and in particular to the user 12 to whom the content item set 18 is presented. If content items 20 may be selected from the content item set 18 that demonstrate both an association with topics that are of potential interest to the user 12 and a positive trending popularity, the resulting presentation 24 is likely to be of significant interest to the user 12, thereby improving the interest level of the presentation 24 to the user 12.

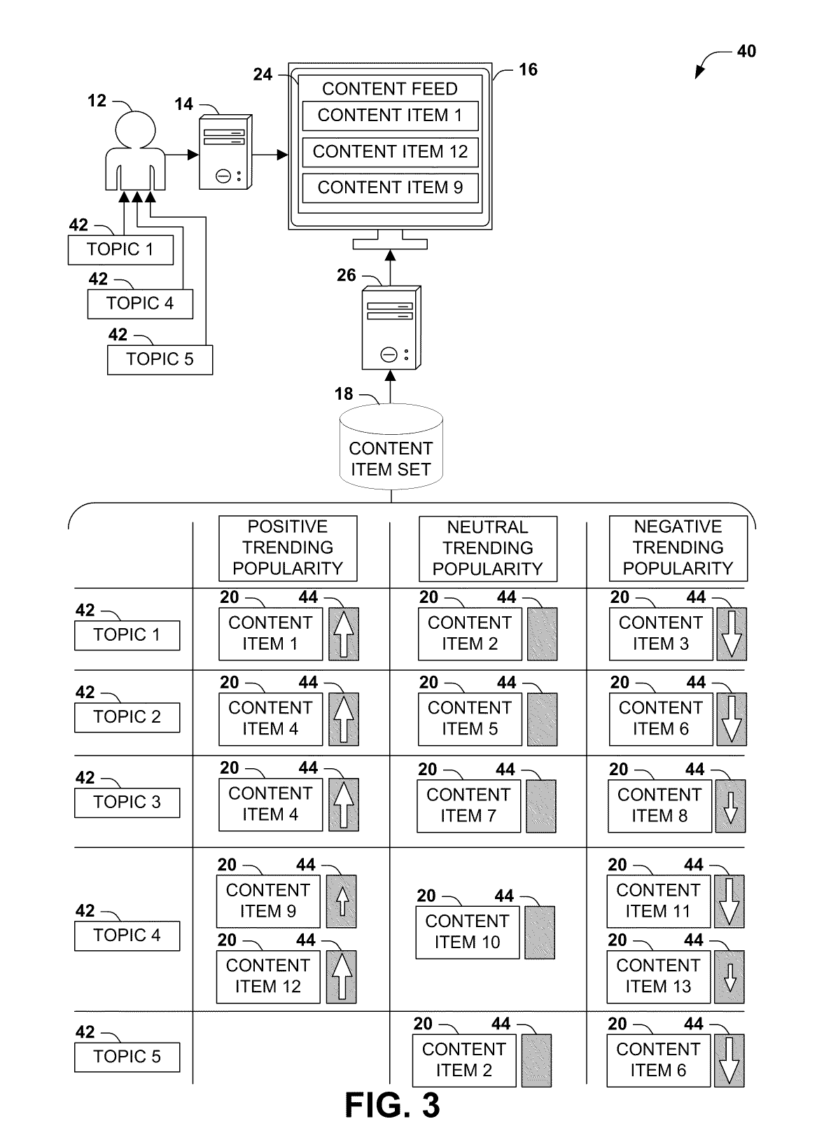

FIG. 3 presents an exemplary scenario 40 featuring the use of the techniques described herein to generate a presentation 24 of a content item set 18 for a user 12 of a device 14. The user 12 is interested in a particular set of topics 42, such as a first topic, a fourth topic, and a fifth topic (which may, e.g., be specified or selected by the user 12, or which may be inferred from the details or actions of the user 12.) The content item set 18 is provided by a content server 26, such as a webserver configured to receive and fulfill requests for presentations 24 of the content item set 18. Respective content items 20 are associated with one or more topics 42, and also with a trending popularity 44, e.g., a comparison of a popularity of a content item 20 at a first time point with a popularity of the same content item 20 at a second time point to determine a trend in the popularity of the content item 20. Some content items 20 may exhibit a positive trending popularity 44 indicative of growing user interest in the content item 20, while other content items 20 may exhibit neutral trending popularity 44, and still other content items 20 may exhibit negative trending popularity 44 indicative of diminishing user interest in the content item 20. Additionally, the trending popularity 44 may be of different magnitudes; e.g., a first content item 20 may exhibit a comparatively large positive trending popularity 44 (illustrated in FIG. 3 by a large upward arrow), while a second content item 20 may exhibit a comparatively small positive trending popularity 44 (illustrated in FIG. 3 by a small upward arrow.)

Within this exemplary scenario 40, a set of content items 20 of potential interest to the user 12 may be selected and presented to the user 12 in the following manner. The topics 42 of interest to the user 12 may be identified, which may be indicative of content items 20 relating to such topics 42 that may be of potential interest to the user 12. Additionally, for respective content items 20, the topics 20 associated with the content item 20 and the trending popularity 44 of the content item 20 may be identified. Based on this information, content items 22 may be selected that are associated with topics 42 of interest to the user 12, and that demonstrate a positive trending popularity 44. These content items 20 may then be presented to the user, e.g., in a presentation 24 displayed on a display 16 attached to the device 14 of the user 12. In this manner, the content item set 18 may be presented to the user 12 with content of potential interest to the user 12. Additional processing may also be applied to improve further the potential interest of the content; e.g., in the exemplary scenario 40 of FIG. 3, the presentation 24 is sorted such that content items 16 having strong positive trending popularity (such as the first content item and the twelfth content item) are presented before content items 16 having weaker positive trending popularity (such as the ninth content item.)

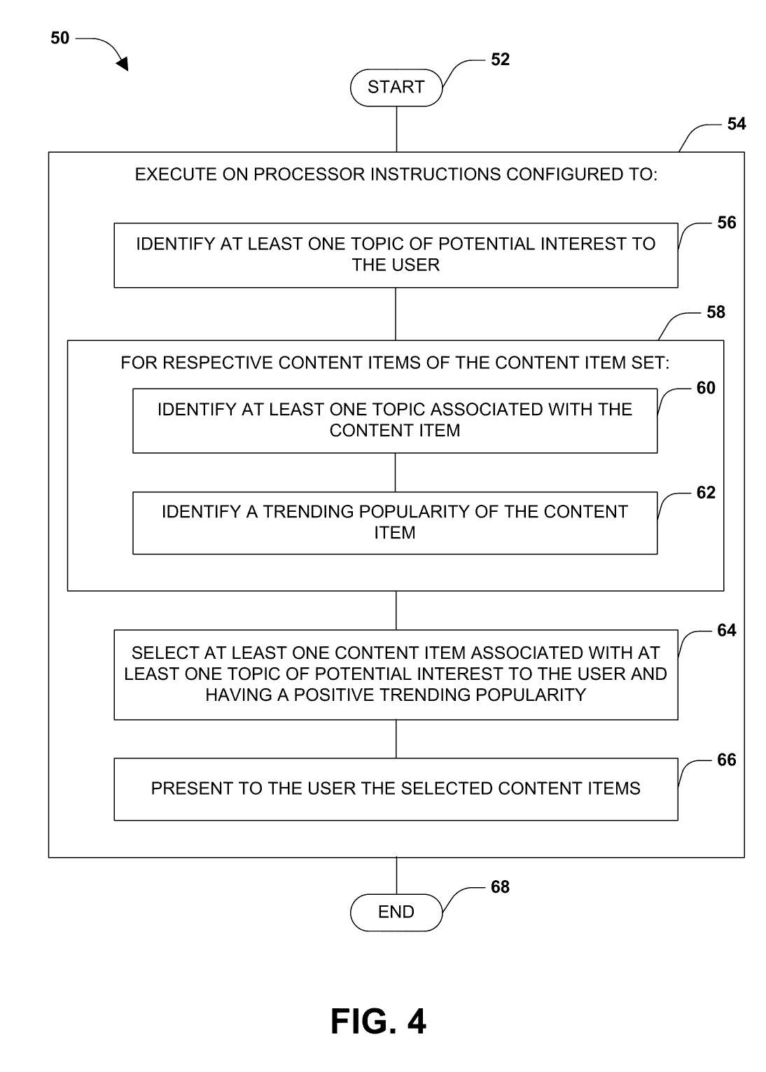

FIG. 4 presents a first embodiment of the techniques presented herein, illustrated as an exemplary method 50 of presenting to a user 12 content items 20 from a content item set 16, where respective content items 20 are associated with at least one topic 42. The exemplary method 50 is performed on a device 14 operated by the user 12 and having a processor. The exemplary method 50 begins at 52 and involves executing 54 on the processor instructions configured to cause the processor to perform various elements of the exemplary method 50 in order to achieve the presentation 24 of the content item set 18 according to the techniques discussed herein. In particular, the instructions are configured to identify 56 at least one topic 42 of potential interest to the user 12. The instructions are also configured to, for respective 58 content items 20 of the content item set 18, identify 60 at least one topic 42 associated with the content item 20, and identify 62 a trending popularity 44 of the content item 20. The instructions are also configured to select 64 at least one selected content item associated with at least one topic 42 of potential interest to the user 12 and having a positive trending popularity 44. The instructions are also configured to present 66 to the user 12 the selected content items. Having achieved the selection and presentation of content items 20 to the user 12 according to the techniques presented herein, the exemplary method 50 ends at 68.

FIG. 70 presents an exemplary scenario 70 featuring a second embodiment of the techniques presented herein, illustrated as an exemplary system 76 configured to present to a user 12 content items 20 from a content item set 18, where respective content items 20 are associated with at least one topic 42, and also with a trending popularity 44. The system 76 operates on a device 72 (such as a content server 26) having a processor 74, e.g., as a volatile or nonvolatile memory comprising software instructions configured to implement the components of the architecture of the exemplary system 76. Such memory may comprise a volatile memory, such as system RAM, or a nonvolatile memory, such as a magnetic or optical storage device (e.g., a hard disk drive or a CD-ROM or DVD-ROM) or a flash memory device. The device 72 is configured to fulfill the requests of users 12 of various devices 14 for a presentation 24 of content from the content item set 18. The exemplary system 76 comprises a topical interest identifying component 78, which is configured to identify at least one topic 42 of potential interest to the user 12. The exemplary system 76 also comprises a content item evaluating component 80, which is configured to, for respective content items 20, identify at least one topic 42 associated with the content item 20, and identify a trending popularity 44 of the content item 20. The exemplary system 76 also comprises a content item selecting component 82, which is configured to select, from the content item set 18, at least one selected content item that is associated (as identified by the content item evaluating component 80) with at least one topic 42 of potential interest to the user 12 (as identified by the topical interest identifying component 78) and having a positive trending popularity 42 (as identified by the content item evaluating component 80.) The exemplary system 76 also comprises a content item presenting component 84, which is configured to present to the user 12 the selected content items. In this manner, the exemplary system 76 causes the device 72 to generate a presentation 24 for the user 12 of the content item set 18 featuring content items 20 that are of potential interest to the user 12, in accordance with the techniques presented herein.

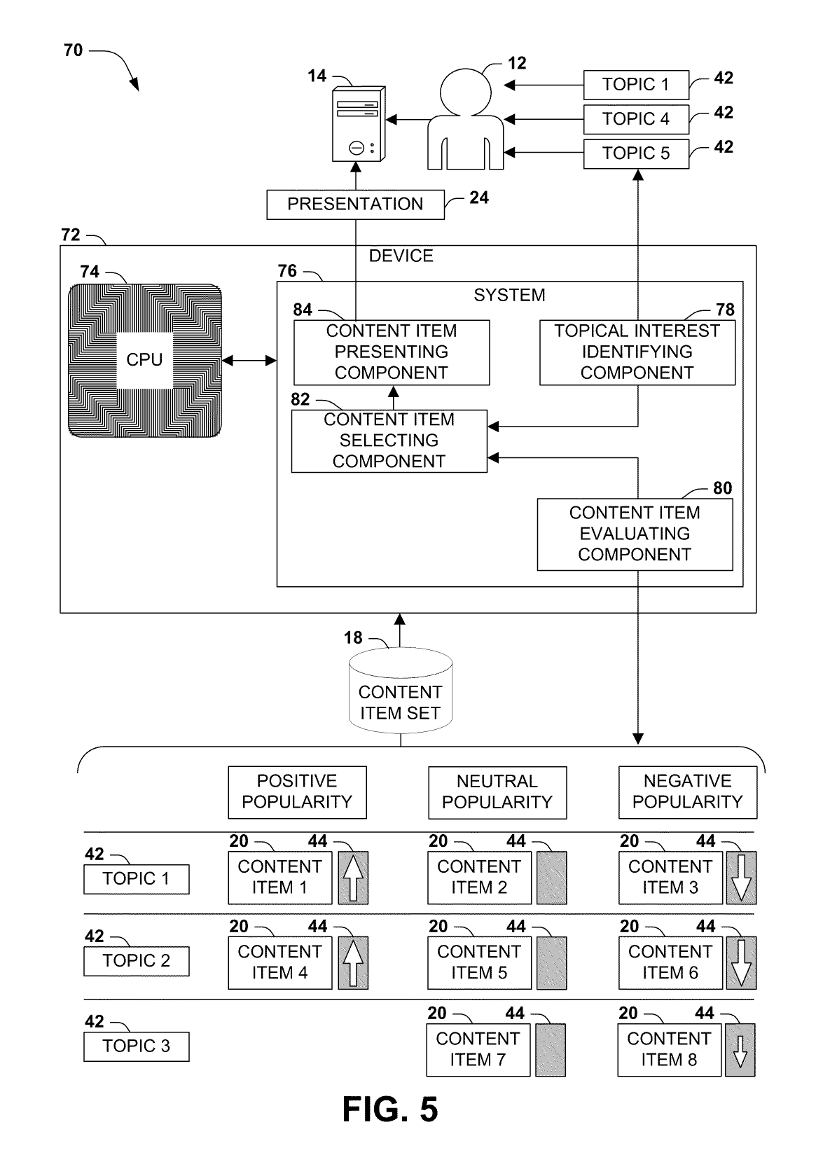

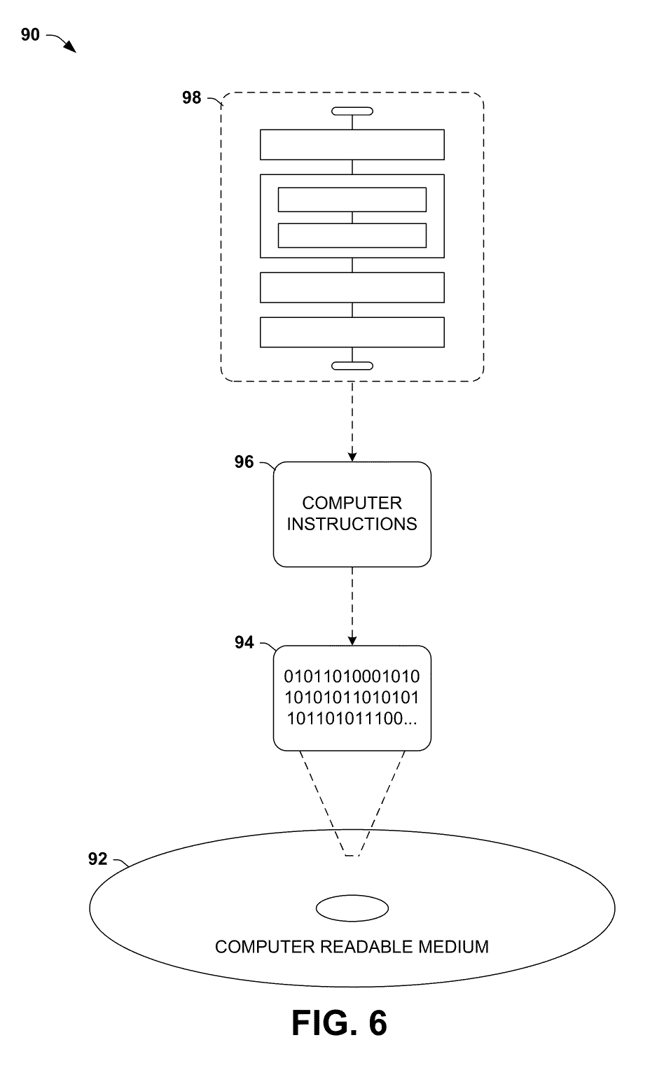

Still another embodiment involves a computer-readable medium comprising processor-executable instructions configured to apply the techniques presented herein. An exemplary computer-readable medium that may be devised in these ways is illustrated in FIG. 6, wherein the implementation 90 comprises a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. In one such embodiment, the processor-executable instructions 96 may be configured to perform a method of presenting to a user content items from a content item set, such as the exemplary method 50 of FIG. 4. In another such embodiment, the processor-executable instructions 96 may be configured to implement a system for presenting to a user content items from a content item set, such as the exemplary system 76 of FIG. 5. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 4 and the exemplary system 76 of FIG. 5) to confer individual and/or synergistic advantages upon such embodiments.

A first aspect that may vary among embodiments of these techniques relates to the scenarios wherein these techniques may be utilized. As a first example, the content item set 18 may comprise many types of content items 20, such as news items posted by a news source, images in an image database, threads of conversation in a forum, and status messages in a social network. As a second example, the techniques may be implemented in many types of devices 72 having access to the content item set 18, such as the machine storing the content item set 18 or a separate machine that accesses the content item set 18. As a third set, the content items 20 may be presented to the user 12 on many types of devices 14, including a workstation or notebook computer having a display component 16, a tablet or other portable device having a small liquid crystal display (LCD), or a mobile phone presenting content items 20 as audio (e.g., by rendering text through a speech engine.) Those of ordinary skill in the art may devise many scenarios wherein the techniques presented herein may be utilized.

A second aspect that may vary among embodiments of these techniques relates to the manner of identifying topics 42 of potential interest to the user 12 (as may be performed, e.g., by the topical interest identifying component 78 in the exemplary system 76 of FIG. 5.) As a first example, an embodiment of these techniques may have access to a user profile comprising at least one user descriptor that describes the user 12, such as the geographic location, demographic information, and/or profession of the user 12. These user descriptors might be expressed by the user 12, or might be inferred or detected by an embodiment of these techniques. The topics 42 of potential interest to the user 12 may then be identified using at least one user descriptor of the user profile of the user 12. As a second example of this second aspect, topics 42 of potential interest to the user 12 may be identified based on the topics 42 that are of interest to associate users of the user 12, e.g., the interests of friends, family members, colleagues, acquaintances, and other social contacts of the user 12 represented on a social network, based on a presumption that such connections may be based on mutual interest in one or more topics 42. For example, an embodiment of these techniques might be configured to identify at least one topic 42 of potential interest to at least one associate user of the user 12, and such potential interests may be attributed to the user 12. As a third example of this second aspect, the actions of the user 12 may be used to identify topics 42 of potential interest to the user 12. For example, upon presenting a selected content item to the user 12, an embodiment of these techniques may be configured to detect an interest of the user 12 in the selected content item, and to record the potential interest of the user 12 in at least one topic 42 that is associated with the selected content item according to the interest of the user in the selected content item. Such recorded interest might be positive (e.g., the actions of the user indicate significant user interest in the content item 20) or negative (e.g., the actions of the user indicate little or no user interest in the content item 20), and such actions may be helpful for determining the topics 42 of potential interest to the user 12.

As a fourth example of this second aspect, various artificial intelligence techniques may be invoked to identify topics 42 of interest to the user in an automated manner. In one such embodiment, an automated classifier, such as a Bayesian classifier, may be trained to identify topics 42 of potential interest to various users 12, and may be invoked (e.g., as the topical interest identifying component 78 in the exemplary system 76 of FIG. 5) to identify topics 42 of potential interest to a particular user 12. Such an automated classifier might rely, e.g., on descriptors in a user profile to determine topics 42 of potential interest to the user 12, and might therefore identify topics 42 of potential interest to a particular user 12 based on the user profile of the user 12. Moreover, when content items 20 relating to a selected topic 42 are subsequently presented to the user 12, the interaction of the user 12 with the selected content item may be detected (e.g., the dwell period of the user 12 on the content item 20), and this information may be used to train the automated classifier in order to produce more accurate predictions of the interest of the user 12 in the topics 42 associated with the content item 20 in order to produce more accurate predictions of the potential interest of such users 12 in such topics 42. For example, the exemplary system 76 of FIG. 5 may include a content item interest detecting component, which may be configured to detect user interest of the user 12 in respective content items 20, and a content item classifier training component, which may be configured to, after detecting the user interest of the user 12 in a particular content item 20, train the content item classifier based on the user 12, the content item 20, and the detected user interest. Those of ordinary skill in the art may devise many ways of identifying topics 42 of potential interest to the user 12 according to the techniques presented herein.

A third aspect that may vary among embodiments of these techniques relates to the manner of identifying one or more topics 42 associated with a content item 20 (as may be performed, e.g., by the content item evaluating component 80 in the exemplary system 76 of FIG. 5.) As a first example, an author 22 of a particular content item 20 may indicate one or more topics 42 associated therewith. As a second example of this third aspect, one or more users 12 may, upon being presented with a content item 20, identify topics 42 associated with the content item 20, and such associations may then be used while selecting the content item 20 for presentation to another user 12. As a third example of this third aspect, the content of the content item 20 may be automatically evaluated to identify the subjects of the content item 20; e.g., an image may be evaluated by a machine vision algorithm to identify people and objects illustrated in the image, while a textual context item comprising a user narrative may be evaluated by a lexical parsing algorithm to identify topics discussed in the user narrative. As a fourth example of this third aspect, at least one topic 42 associated with a topical identifier, such as a keyword or a “hashtag” identifier beginning with a hash character and followed by a name of the topic 42, and the topics 42 associated with a content item 20 may be identified by detecting one or more topical identifiers associated with the content item 20.

As a fifth example of this third aspect, the topics 42 associated with a content item 20 may be circumstantially identified. For example, a content item 20 comprising a photo may include a geocode indicating the location of the photo and a date on which the photo was captured, and one or more topics 42 that are likely to be linked with this content item 20 (such as landmarks that are often photographed and that are located near the location of the photo, or an event occurring at the location and time matching the location and date of the photo) may be selected and associated with the content item 20. As a sixth example of this third aspect, a first content item 20 may be compared to a second content item 20 that is already associated with a topic 42, and comparative similarities between these content items 20 may be identified to associate the first content item 20 with the same topic 42 as the second content item 20. For example, a content item 20 comprising a first news article about a particular incident may be compared with other news articles, and if a comparatively similar news article (e.g., written on the same date, sharing particular names and keywords, and linking to the same resources) is identified that relates to one or more topics 42, such topics 42 may also be associated with the first news article.

As a sixth example of this third aspect, artificial intelligence techniques may be utilized to identify topics 42 associated with various content items 20. For example, an automated topical classifier, such as a Bayesian classifier, may be trained to identify topics associated with various content items 20, and following training, may be invoked to identify the topics 42 associated with a particular content item 20. Those of ordinary skill in the art may devise many ways of identifying one or more topics 42 associated with a content item 20 while implementing the techniques presented herein.

A fourth aspect that may vary among embodiments of these techniques relates to the manner of identifying a trending popularity of a content item 20 (as may be performed, e.g., by the content item evaluating component 80 in the exemplary system 76 of FIG. 5.) As a first example of this fourth aspect, various metrics of user interaction with a particular content item 20 may be selected to identify the popularity of the content item 20 at a particular time. For example, embodiments may utilize as metrics of popularity the number of accesses of the content item 20 (such as the request rate of a web resource, as may be identified through webserver logs), the number of search queries submitted to a search engine that produce the content item 20 in the result set of the search query, and/or the number of links to the content item 20 (such as the URL of a web resource) that may be posted by various users 12 of a social network or a weblog collection. Such metrics might indicate large popularity of the content item 20 (e.g., a large number of requests for the content item 20) or small popularity of the content item 20 (e.g., few or zero requests for the content item 20.)

As a second example of this fourth aspect, an embodiment might identify the popularity of a content item 20 based on more active or explicit indicators of user activity. In a first such embodiment, after presenting a content item 20 to a user 12, the embodiment may detect a dwell period of the user 12 on the content item 20 (e.g., by monitoring the amount of time that the user 12 spends reviewing the content item 20, or the extent to which the user 12 reviews the content item 20, such as the amount of an article through which the user 12 may scroll), and may record the dwell period of the user 12 on the content item 20. The popularity of the content item 20 may then be determined according to the dwell periods of one or more users 12 on the content item 20. In a second such embodiment, when presenting a content item 20 to the user 12, the embodiment may present with the content item 20 a popularity selector, such as “Like” and “Do Not Like” buttons associated with the content item 20, which the user 12 may activate to indicate the user's view of the popularity of the content item 20. Upon receiving from the user 12 a user selection of the popularity selector (such as an indication that the user 12 has clicked a “Like” button), the embodiment may record the user selection for the content item 20, and the popularity of the content item 20 may be determined according to the recorded user selections of the popularity selectors for the content item 20. In a third such embodiment, one or more content items 20 may be the subject of a transaction (e.g., a viewing, a downloading or use of a software object, or a purchasing of a resource, and the popularity of the content item 20 may be measured according to the number or rate of such transactions. In a fourth such embodiment, popularity may be identified based on a transfer of content items 20 among users 12, such as a recommendation of the content item 20 by a user 12 to an associate user, or a copying by the user 12 of a content item 20 presented by an associate user 12. For example, an associate user may generate a user content item set, such as a set of content items 20 that are of particular interest to the associate user, and that the associate user wishes to share with others. An embodiment of these techniques may, upon the request of the user 12, present the user content item set of the associate user, and the popularity of respective content items 20 of the user content item set may be identified by detecting a transfer of the content item from the associate user to the user 12 (e.g., the user 12 may select the content item 20 for inclusion in his or her own user content item set.) Moreover, an embodiment of these techniques may also use these metrics to identify a potential interest of the user 12 in one or more topics 42 that are associated with the content items 20 with which the user 12 interacts.

As a third example of this fourth aspect, the metrics of popularity of a particular content item 20 (including those discussed in previous examples of this fourth aspect) may be used in various ways to identify the trending popularity of a content item 20. In a first such embodiment, the trending popularity 44 of a particular content item 20 may be determined by tracking the popularity of the content item 20 over time, e.g., by identifying a first popularity of the content item 20 at a first time, identifying a second popularity of the content item 20 at a second time, and comparing the first popularity and the second popularity to identify the trending popularity 44 of the content item 20. In a second such embodiment, a set of highly popular content items 20 at a particular time may be identified, and content items 20 appearing in the list that have not appeared in a previous list may be identified as having a positive trending popularity. Those of ordinary skill in the art may devise many ways of identifying the trending popularities of various content items 20 while implementing the techniques presented herein.

A fifth aspect that may vary among embodiments of these techniques relates to the manner of selecting content items 20 for inclusion in the presentation 24 to the user 12. While, in accordance with these techniques, the content items 20 selected for inclusion are associated with one or more topics 42 of potential interest to the user 12 and demonstrate a positive trending popularity 44, many ways of selecting content items 20 from the content item set 18 in accordance with these criteria may be devised. As a first example of this fifth aspect, a simple heuristic may be utilized; e.g., all content items 20 meeting these criteria may be selected for presentation to the user 12. As a second example of this fifth aspect, a subset of these content items may be selected 20 in a simple manner; e.g., a particular number of newest content items 20 matching these criteria may be selected, and/or content items 20 that have previously been presented to the user 12 may be removed from the presentation 24.

Other variations of this fifth aspect may demonstrate additional selectivity that may further improve the potential interest of the presentation 24 to the user 12. As a third example of this fifth aspect, mathematical formulae or logical heuristics may be utilized to identify and select content items 20 that are of higher potential interest to the user 12 among all content items 20 meeting these criteria. For example, scores may be attributed to the potential interest of the user 12 in various topics 42 (e.g., topics 42 of great interest to the user 12 having higher scores), to the association of a particular content item 20 with a particular topic 20 (e.g., content items 20 relating predominantly to the topic 20 having higher scores than content items 20 only passingly related to the topic 20), and/or to the trending popularity of the content item 20 (e.g., content items having a higher positive trending popularity having higher scores.) For content items 20 meeting the criteria of the techniques presented herein, a content item score may be computed as a product of these three scores, and the content items 20 having the highest scores may be selected for presentation to the user 12.

As a fourth example of this fifth aspect, various artificial intelligence techniques may be utilized to select content items 20 of potential interest to a user 12. In a first such embodiment, an artificial neural network may be configured (e.g., via training on sample data sets and feedback training mechanisms) to select content items 20 of potential interest to various types of users 12, and the artificial neural network may be invoked to select content items 20 from the content item set 18 for presentation 24 to a particular user 12. In a second such embodiment, an automated classifier, such as a Bayesian classifier, may be trained to classify topics 42 according to a potential interest level of the user 12, e.g., by classifying content items 20 as of high potential interest, medium potential interest, and low potential interest to the user 12, based on the details of the content item 20 (including the topics 42 associated therewith) and the details of the user 12 (including the descriptors of the user 12 stored in a user profile.) An embodiment of these techniques (such as the content item selecting component 82 of the exemplary system 76 of FIG. 5) may invoke the automated classifier to identify the potential interest of a particular content item 20 to a particular user 12 while selecting content items 20 for presentation thereto. Moreover, for content items 20 selected for presentation to the user 12, the interaction of the user 12 with the selected content item may be detected (e.g., the dwell period of the user 12 on the content item 20), and this information may be used to train the automated classifier in order to produce more accurate classifications of potential interest of such users 12 in such content items 20. Those of ordinary skill in the art may devise many ways of selecting content items 20 from the content item set 18 for presentation to the user 12 while implementing the techniques discussed herein.

A sixth aspect that may vary among embodiments of these techniques relates to the manner of presenting the selected content items to the user 12. As a first example, the selected content items may simply be presented as a collection, such as a horizontal or vertical list of textual content items 20 or a tiled thumbnail gallery of image content items 20. In these presentations, the content items 20 may be sorted according to at least one sorting criterion; e.g., the content items 20 may be sorted by date (including a specific moment in time) according to a date sorting criterion (e.g., with newer content items 20 presented before older content items 20); by author 22 according to a content item author sorting criterion (e.g., with content items 20 generated by authors 22 having closer associations with the user 12, such as family members, presented before content items generated by authors 22 having more distant associations with the user 12, such as passing acquaintances); by popularity according to a popularity sorting criterion (e.g., with content items 20 of great popularity presented before content items 20 of less popularity); and/or by trending popularity based on a trending popularity sorting criterion (e.g., with content items 20 having a higher positive trending popularity presented before content items having a lower positive trending popularity.)

As a second example, the selected content items may be presented in view of an association of the user 12 with at least one associate user who may generate and maintain a user content item set, such as a subset of content items 20 that the associate user wishes to share with other users. In a first such embodiment, the device 14 of the user 12 may present the content items 20 of the user content item set of the associate user in a first region of a display 16 attached to the device 14, and may concurrently present the content items 20 selected by the techniques presented herein in a second region of the display 16. For example, the device 14 may display a first column of content items 20 comprising the user content item set of an associate user of the user 12, and a second column, adjacent to the first column, comprising the selected content items that are of potential interest to the user 12. In a second such embodiment, the device 14 may present the selected content items within the user content item set of the associate user of the user 12, e.g., by filtering the user content item set to those content items 20 that also match the criteria of the techniques discussed herein (e.g., associated with at least one topic 20 of potential interest to the user 12 and also having a positive trending popularity), and/or by inserting the selected items into the user content item set of the associate user of the user 12. Those of ordinary skill in the art may devise many ways of presenting the selected content items to the user 12 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

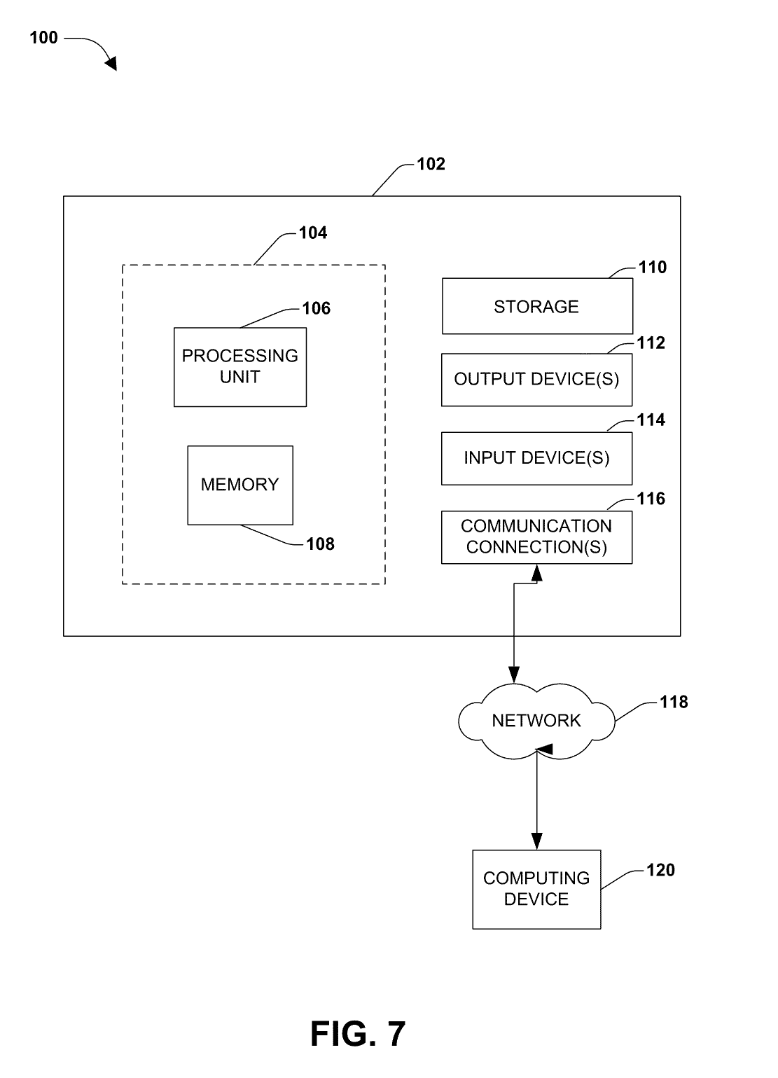

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 100 comprising a computing device 102 configured to implement one or more embodiments provided herein. In one configuration, computing device 102 includes at least one processing unit 106 and memory 108. Depending on the exact configuration and type of computing device, memory 108 may be volatile (such as RAM, for example), non-volatile (such as ROM, flash memory, etc., for example) or some combination of the two. This configuration is illustrated in FIG. 7 by dashed line 104.

In other embodiments, device 102 may include additional features and/or functionality. For example, device 102 may also include additional storage (e.g., removable and/or non-removable) including, but not limited to, magnetic storage, optical storage, and the like. Such additional storage is illustrated in FIG. 7 by storage 110. In one embodiment, computer readable instructions to implement one or more embodiments provided herein may be in storage 110. Storage 110 may also store other computer readable instructions to implement an operating system, an application program, and the like. Computer readable instructions may be loaded in memory 108 for execution by processing unit 106, for example.

The term “computer readable media” as used herein includes computer storage media. Computer storage media includes volatile and nonvolatile, removable and non-removable media implemented in any method or technology for storage of information such as computer readable instructions or other data. Memory 108 and storage 110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 102. Any such computer storage media may be part of device 102.

Device 102 may also include communication connection(s) 116 that allows device 102 to communicate with other devices. Communication connection(s) 116 may include, but is not limited to, a modem, a Network Interface Card (NIC), an integrated network interface, a radio frequency transmitter/receiver, an infrared port, a USB connection, or other interfaces for connecting computing device 102 to other computing devices. Communication connection(s) 116 may include a wired connection or a wireless connection. Communication connection(s) 116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 102 may include input device(s) 114 such as keyboard, mouse, pen, voice input device, touch input device, infrared cameras, video input devices, and/or any other input device. Output device(s) 112 such as one or more displays, speakers, printers, and/or any other output device may also be included in device 102. Input device(s) 114 and output device(s) 112 may be connected to device 102 via a wired connection, wireless connection, or any combination thereof. In one embodiment, an input device or an output device from another computing device may be used as input device(s) 114 or output device(s) 112 for computing device 102.

Components of computing device 102 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 102 may be interconnected by a network. For example, memory 108 may be comprised of multiple physical memory units located in different physical locations interconnected by a network.

Those skilled in the art will realize that storage devices utilized to store computer readable instructions may be distributed across a network. For example, a computing device 120 accessible via network 118 may store computer readable instructions to implement one or more embodiments provided herein. Computing device 102 may access computing device 120 and download a part or all of the computer readable instructions for execution. Alternatively, computing device 102 may download pieces of the computer readable instructions, as needed, or some instructions may be executed at computing device 102 and some at computing device 120.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting to a user content items from a content item set, respective content items associated with at least one topic, the method performed on a device having a processor and comprising:
executing on the processor instructions configured to:
identify at least one topic of potential interest to the user;
for respective content items of the content item set:
identify at least one topic associated with the content item, and
identify a trending popularity of the content item;
select at least one selected content item associated with at least one topic of potential interest to the user and having a positive trending popularity; and
present to the user the selected content items.

2. The method of claim 1, identifying at least one topic of potential interest to the user comprising: after presenting a selected content item to the user:
detecting an interest of the user in the selected content item, and
recording the potential interest of the user in at least one topic associated with the selected content item according to the interest of the user in the selected content item.

3. The method of claim 1:
the user associated with at least one associate user; and
identifying the at least one topic of potential interest to the user comprising: identifying at least one topic of potential interest to at least one associate user who is associated with the user.

4. The method of claim 1:
at least one topic associated with a topical identifier; and
identifying the at least one topic associated with a content item comprising: detecting a topical identifier of a topic associated with the content item.

5. The method of claim 1, identifying the trending popularity of a content item comprising:
identifying a first popularity of the content item at a first time;
identifying a second popularity of the content item at a second time that is later than the first time; and
comparing the first popularity of the content item and the second popularity of the content item to identify a trending popularity of the content item.

6. The method of claim 5:
the method comprising: after presenting a selected content item to the user:
detecting a dwell period of the user on the selected content item, and
recording the dwell period of the user on the selected content item; and
identifying the popularity of the content item comprising: identifying the popularity of the content item according to the dwell periods of the popularity selector of users on the content item.

7. The method of claim 5:
presenting to the user a selected content item comprising:
presenting with the selected content item a popularity selector, and
upon receiving from the user a user selection of the popularity selector, recording the user selection for the selected content item; and
identifying the popularity of the content item comprising: identifying the popularity of the content item according to the user selections of the popularity selector of the content item.

8. The method of claim 5:
the user associated with at least one associate user;
at least one content item selected by the associate user for a user content item set; and
identifying the popularity of the content item comprising: after presenting the content item to the user in the user content item set of the associate user, detecting a transfer of the content item from the associate user to the user.

9. The method of claim 1, presenting the selected content items comprising:
sorting the selected content items according to at least one sorting criterion, and
presenting to the user the selected content items sorted according to the at least one sorting criterion.

10. The method of claim 9, at least one sorting criterion selected from a sorting criterion set comprising:
a date sorting criterion;
a content item author sorting criterion;
a popularity sorting criterion; and
a trending popularity sorting criterion.

11. The method of claim 1, the user associated with at least one associate user.

12. The method of claim 11:
respective content items generated by at least one author, and
selecting the at least one selected content item comprising: selecting at least one selected content item associated with at least one topic of potential interest to the user, having a positive trending popularity, and generated by at least one author who is an associate user of the user.

13. The method of claim 11:
at least one content item selected by the associate user for a user content item set; and
presenting the at least one selected content item comprising:
presenting in a first region of a display of the user the content items of the user content item set of the associate user, and
presenting in a second region of the display of the user, concurrently with presenting the user content item set, the at least one selected content item.

14. The method of claim 11:
at least one content item selected by the associate user for a user content item set; and
presenting the at least one selected content item comprising:
presenting to the user at least one content item within the user content item set of the associate user, associated with at least one topic of potential interest to the user, and having a positive trending popularity.

15. A system configured to present to a user content items from a content item set, respective content items associated with at least one topic, the system comprising:
a topical interest identifying component configured to identify at least one topic of potential interest to the user;
a content item evaluating component configured to, for respective content items:
identify at least one topic associated with the content item, and
identify a trending popularity of the content item;
a content item selecting component configured to select at least one selected content item associated with at least one topic of potential interest to the user and having a positive trending popularity; and
a content item presenting component configured to present to the user the selected content items.

16. The system of claim 15, the content item topic identifying component comprising a topical classifier configured to identify topics associated with respective content items based on the content item.

17. The system of claim 15:
the system having access to a user profile comprising at least one user descriptor that describes the user; and
the topical interest identifying component configured to identify the at least one topic of potential interest to the user using at least one user descriptor of the user profile of the user.

18. The system of claim 17:
the system having access to a content item classifier configured to select content items of potential interest to a user based on the content item and at least one user descriptor of the user; and
the content item selecting component configured to select the at least one selected content item by:
invoking the content item classifier with a content item and the at least one user descriptor of the user, and
presenting to the user at least one content item selected by the content item classifier and having a positive trending popularity.

19. The system of claim 18, comprising:
a content item interest detecting component configured to detect user interest of the user in respective content items; and
a content item classifier training component configured to, after detecting the user interest of the user in a content item, train the content item classifier based on the user, the content item, and the user interest.

20. A computer-readable storage medium comprising instructions that, when executed on a device having a user associated with at least one associate user, present to the user content items from a content item set, respective content items generated by at least one author and associated with at least one topic, and the device having access to a user profile comprising at least one user descriptor that describes the user and a content item classifier configured to select content items of potential interest to a user based on the content item and at least one user descriptor of the user, by:
identifying at least one topic of potential interest to the user by identifying at least one topic of potential interest to at least one associate user who is associated with the user;
for respective content items of the content item set:
identifying at least one topic associated with the content item by detecting a topical identifier of a topic associated with the content item, and
identifying a trending popularity of the content item by:
identifying a first popularity of the content item at a first time;
identifying a second popularity of the content item at a second time that is later than the first time; and
comparing the first popularity of the content item and the second popularity of the content item to identify a trending popularity of the content item;
selecting at least one selected content item associated with at least one topic of potential interest to the user, having a positive trending popularity, and generated by at least one author who is an associate user of the user, by invoking the content item classifier with a content item and the at least one user descriptor of the user;
presenting to the user the selected content items by:
sorting the selected content items according to at least one sorting criterion selected from a sorting criterion set comprising:
a date sorting criterion;
a content item author sorting criterion;
a popularity sorting criterion; and
a trending popularity sorting criterion; and
presenting to the user the selected content items sorted according to the at least one sorting criterion;
presenting with the selected content item a popularity selector;
upon receiving from the user a user selection of the popularity selector, recording the user selection for the selected content item; and
after presenting a selected content item to the user:
detecting an interest of the user in the selected content item by:
detecting a transfer of the content item by an associate user of the user;
detecting a dwell period of the user on the selected content item; and
recording a user interest of the user in at least one topic associated with the selected content item according to the interest of the user in the selected content item; and
training the content item classifier based on the user, the content item, and the user interest.
